(19) United States
(12) Patent Application Publication
(10) Pub. No.: US 2006/0085232 A1
(43) Pub. Date: Apr. 20, 2006

(54) Automated remote access password-authenticated hunting and fishing reservation system

(76) Inventor: Rodney S. Rice, Boerne, TX (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(21) Appl. No.: 11/252,386

(22) Filed: Oct. 17, 2005

Related U.S. Application Data
(60) Provisional application No. 60/619,333, filed on Oct. 15, 2004.

(51) Int. Cl. G06Q 10/00

(52) U.S. Cl. 705/5

(57) ABSTRACT

Embodiments of the present invention provide a computerized system for forming a network of member hunters and fishermen and member landowners for processing request and/or reservation of such landowner's property for use in hunting and/or fishing activities by member hunters and fishermen through at least one central processing unit, storage means containing the identification of network members, means for network member hunters and fishermen to request reservation of network member landowner property, means for network member hunter and fisherman to identify property to be reserved and/or ability to review attributes and information about potential properties, and means for network member property owners to identify attributes of requesting network member hunter and fishermen in order to base an acceptance or rejection of such reservation request.

### CROSS-REFERENCE TO RELATED APPLICATIONS

The present application claims the benefit of U.S. Provisional Patent Application No. 60/619,333, entitled “Automated Remote Access Password-Authenticated Hunting and Fishing Reservation System,” and filed on Oct. 15, 2004. The aforementioned application is hereby incorporated by reference herein in its entirety for all purposes.

### BACKGROUND OF THE INVENTION

1. Field

The present invention relates generally to automated reservation systems, and more particularly to an automated reservation system and methods for access to hunting and fishing resources owned by other parties.

2. Description of Related Art

Hunters and fishermen often encounter difficulty in gaining and/or reserving access to land and water resources owned by other parties. Often, a sportsman must approach a landowner directly and in person to request access to the landowner's property. Such direct, in-person contact may often discourage the landowner from charging a fee for use of the land, even if the sportsman would be willing to pay a fee. If the landowner is not present, the sportsman will be unable to use the landowner's land, even if the sportsman is willing to pay for such use.

In addition, hunters (and fishermen) may often be denied access to particular property due to a landowner's inability to effectively track usage and/or verify authenticity of authorized hunters aside from face-to-face direct interaction with the hunters. Currently, landowners also often encounter difficulty in sharing information about particular hunters with other landowners, and hunters often encounter difficulty in sharing information about particular landowners or parcels with other hunters and landowners. Therefore, there is a need in the art for improved systems and methods for reserving access to hunting and fishing resources owned by other parties.

### BRIEF SUMMARY OF THE INVENTION

Embodiments of the present invention relate generally to automated reservation systems, and more particularly to an automated reservation system and methods for access to hunting and fishing resources owned by other parties. According to some embodiments, a field-based, password-authenticated solution allows for convenient, flexible leasing of land while allowing landowners to control and audit access in a streamlined and automated fashion. Embodiments of the present invention provide for efficient, real-time connection of hunters and fishermen to landowners via a remote, field-based password-authenticated reservation system for the leasing of land and water for permitted hunting and fishing use by day, day-part, week, year or season. Use of such a system may permit hunters and fishermen access a field-based device, gather information about a particular property, reserve the property based on a unique property identifier, pay for such use, and receive back a pass code authenticating such use in the field should the hunter or fisherman be requested to provide proof of access rights.

Methods for reservation of land access activities are provided according to embodiments of the present invention. Such embodiments of methods may include, but are not limited to, receiving parcel information via a network for a parcel associated with a particular landowner, where the parcel information may include a geographic identification of the parcel, usage availability of the parcel, and usage pricing of the parcel. Such embodiments of methods may further include storing the parcel information in a parcel database containing information about one or more parcels, receiving request information via the network for a desired parcel, the request information including an identification of the desired parcel, selecting a parcel from the plurality of parcels using criteria based on the request information, and generating an access code granting physical access to the selected parcel for use in conformance with the parcel information. In some cases, the access code may be a combination for opening a security gate or other security device configured to prohibit public access. In other cases, receiving request information via the network for the desired parcel includes receiving information identifying the desired parcel selected from a list of parcels, such as, for example, a list of parcels ordered by alphabetical order, geographic proximity order, and/or rating score order. In some instances, the identification of the desired parcel is a unique identification number associated with the desired parcel, and selecting the parcel from the plurality of parcels using criteria based on the request information includes selecting the parcel associated with the unique identification number from the plurality of parcels.

According to some embodiments of the methods, the methods may further include receiving information about a payment source from a hunter interested in using the selected parcel, verifying that the payment source is sufficient to satisfy the usage pricing for the selected parcel, and debiting the payment source for an amount according to the usage pricing for the selected parcel. In some cases, the embodiments of methods may further include generating an activity report for a landowner, the activity report listing the access codes and reservation times for use of the selected parcel. In other cases, the embodiments of methods may include receiving a rating score for the selected parcel from a user of the parcel, storing the rating score in the database, calculating an average rating score based on the rating score and other rating scores stored in the database and associated with the selected parcel, and displaying the average rating score. In yet other cases, the embodiments of methods may include receiving from a landowner a rating score for a user of the landowner's parcel, storing the rating score in the database, calculating an average rating score based on the rating score and other rating scores stored in the database and associated with the user, and displaying the average rating score.

Systems for reservation of land access activities are provided according to embodiments of the present invention. Such embodiments of systems may include, for example, a computer communicably coupled to a computer readable medium and a network, and the computer readable medium may include instructions executable by the computer to receive parcel information via the network for a parcel associated with a particular landowner, the parcel information including a geographic identification of the parcel, usage availability of the parcel, and usage pricing of the parcel. The computer may further include instructions executable by the computer to store the parcel information in a parcel database containing information about a plurality of parcels, receive request information via the network for a desired parcel, the request information including an identification of the desired parcel, select a parcel from the plurality of parcels based on the request information, and generate an access code granting physical access to the parcel for use in conformance with the parcel information.

Methods for reservation of land access activities are provided according to embodiments of the present invention. Such embodiments of methods may include receiving parcel information via a network for a plurality of available parcels, the parcel information including geographic identification of each parcel of the plurality of available parcels, usage availability of each parcel of the plurality of available parcels, and usage pricing of each parcel of the plurality of available parcels. Such embodiments of methods may further include, for example, storing the parcel information in a parcel database, receiving request information via the network for a desired parcel, the request information including an identification of the desired parcel, selecting a parcel from the plurality of available parcels using criteria based on the request information, and generating an access code granting physical access to the parcel for use in conformance with the parcel information associated with the parcel.

Methods for reserving access to hunting or fishing land are provided, according to embodiments of the present invention. Such embodiments of methods include listing a parcel of land as available for hunting or fishing via an access reservation system, posting a unique identification code associated with the parcel of land on or adjacent to the parcel of land, accessing the access reservation system to enter the unique identification code, querying availability of the parcel of land based on the unique identification code, and reserving the parcel of land based on the availability. In some instances of the embodiments, reserving the parcel of land may include generating a unique passcode for authenticating a user's right to use the parcel of land for a particular time period. In other instances of the embodiments, accessing the access reservation system includes communicating with the access reservation system via a communications system such as, for example, a telephone system, a network system, an internet system, and/or a wireless network system.

This summary provides only a general outline of some embodiments of the present invention. Many other objects, features, advantages and other embodiments of the present invention will become more fully apparent from the following detailed description, the appended claims and the accompanying drawings.

### BRIEF DESCRIPTION OF THE SEVERAL VIEWS OF THE DRAWING

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates a reservation system according to embodiments of the present invention.

FIG. 2 illustrates a flow diagram depicting various methods for using a remote access reservation system according to some embodiments of the present invention.

FIG. 3 illustrates a flow diagram depicting methods for reserving access to parcels, according to various embodiments of the present invention.

FIG. 4 illustrates a flow diagram depicting methods for listing parcels, according to various embodiments of the present invention.

FIG. 5 illustrates an exemplary computer system according to embodiments of the present invention.

FIG. 6 illustrates a flow diagram depicting methods for remote access reservation of parcels according to embodiments of the present invention.

### DETAILED DESCRIPTION OF THE INVENTION

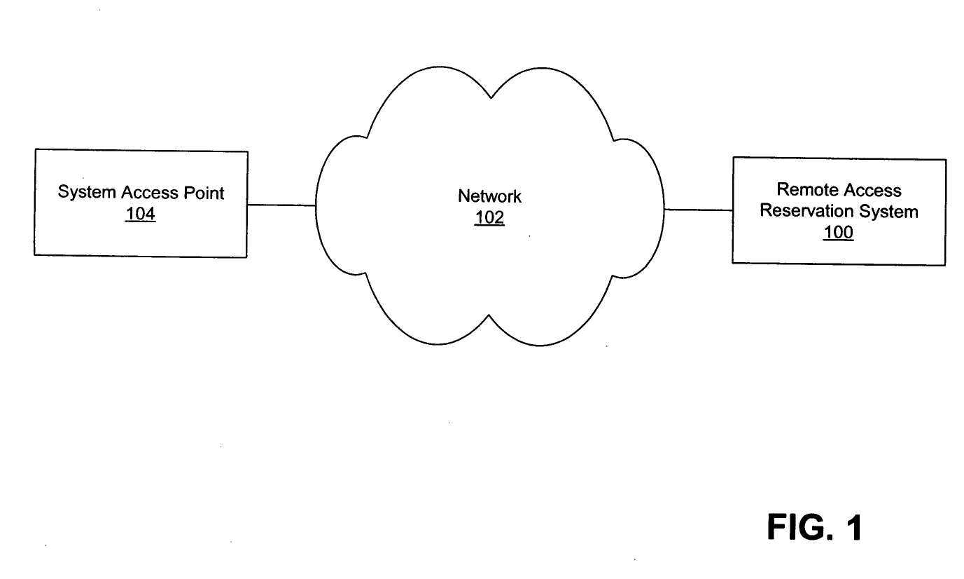

According to embodiments of the present invention, landowners may subscribe to membership with a hunter access reservation system, and in doing so may contribute their land and/or water (or portion thereof) as inventory to be leased, reserved, and/or loaned by member hunters and/or fishermen. FIG. 1 illustrates one example of a reservation system according to embodiments of the present invention. A remote access reservation system (“RARS”) 100 is communicably coupled to a network 102. A system access point (“SAP”) is also communicably coupled to network 104. RARS 100 and/or SAP 104 may be implemented as a computer system 500, for example. According to some embodiments of the present invention, users of RARS 100 may access RARS 100 through SAP 104. As used herein, the term “hunters” is used in its broadest sense, and is used to refer to any person or entity seeking access to land for the purposes of recreational activities including, for example, but not limited to, hunting, fishing, boating, camping, hiking, kayaking, sports, and/or other land use activities.

Some embodiments of the present invention provide systems and methods for reserving access to parcels through a network. Such systems and methods can be implemented using computers and computer software. Such computer software can be maintained on a computer readable medium. As used herein, the term “computer readable medium” is used in its broadest sense to mean any storage device accessible to a computer. Thus, for example, a computer readable medium can be a hard disk drive, a RAM, a floppy diskette, a CD ROM, an EEPROM, a magnetic tape, and/or the like. In some cases, the computers and/or computer software can communicate via a network. In particular, the computers can be communicably coupled to a network and/or each other. As used herein, the term “network” is used in its broadest sense to mean any system capable of passing communications from one entity to another. Thus, for example, a network can be, but is not limited to, the Internet, a virtual private network, a local area network, a wide area network, a WiFi network, a PSTN, a cellular network, and/or any combination thereof. Further, the term “communicably coupled” is used herein in its broadest sense to mean any coupling whereby information may be passed. Thus, for example, communicably coupled includes electrically coupled by, for example, a wire; optically coupled by, for example, an optical cable; and/or wirelessly coupled by, for example, a radio frequency or other transmission media.

A SAP 104 may be, for example, an email client, a website, wireless web, a fax, a phone, cell text client, a text messaging client and/or an interactive voice response unit or prompter. Member landowners may provide, via SAPs 104, information and details regarding their property or specific areas within their property, including but not limited to geographic location (e.g. county, state, distance from city, GPS coordinates), size, water, elevation, types of terrain, types of crops, types of wildlife, wildlife counts, access times available, number of hunters allowed, text, audio, pictures, satellite imagery and video descriptions of the property or current conditions of the property, game and facilities and rules of use (i.e. property information).

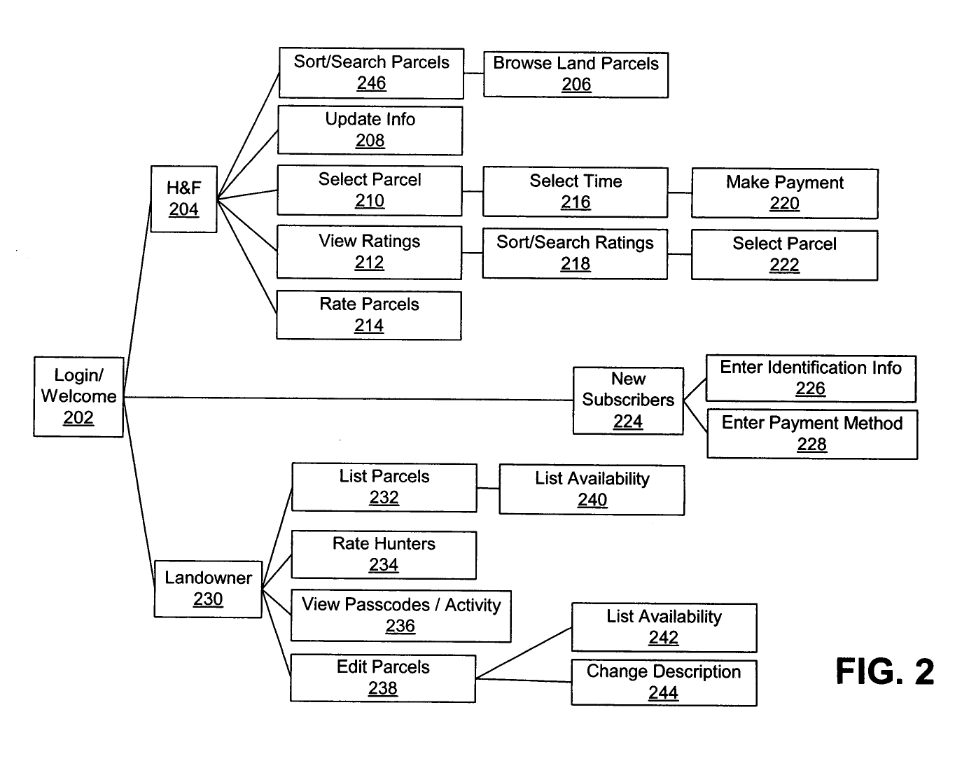

FIG. 2 conceptually illustrates various methods for using a remote access reservation system 100, such as, for example, through a web browser interface, according to some embodiments of the present invention. Users of system 100 may begin with a login/welcome screen 202. From block 202, at least three options may be chosen. Hunters may connect to a hunter module/screen 204, a new subscriber module/screen 224, or a landowner module/screen 230. From hunter module 204, the user may access user module 208 to update his or her profile including, but not limited to, personal contact information, payment information, personal demographic information, personal usage statistics and ratings. From hunter module 204, users may also directly access module 210 in order to select a parcel for reservation by entering the parcel's unique property identifier into system 100; alternatively, users may select the parcel from a list of parcels created through browsing (module 206), sorting, or searching (module 246), for example. Users may then query for availability, view details regarding such parcel and reserve such parcel. Optional modules 216 and 220 permit a user to, respectively, select a particular time over which the reservation of the selected parcel will be valid, and make payment for the reservation, where applicable. According to some embodiments of the present invention, a view ratings module 212 may permit a user to view the ratings of certain parcels based on feedback from other hunters and/or landowners, and may also permit a user to sort or search such ratings via module 218, and to select a parcel via module 222, similarly to parcel selection via module 210; such a view ratings module 212 may alternatively be integrated with the sorting/searching functions performed by module 246.

From hunter module 204, users may also utilize module 246 in order to search for parcels using one or more combinations of search parameters, including, but not limited to, geography, types of game, price for access, date specific, availability, the duration a property can be reserved, the number of hunters which can utilize a property at once and ratings scores, both generally as well as for specific types of game, times of year and a combination of these two ratings parameters, for example. Such search results can be weighted in their return more or less heavily by parameter and/or sorted by parameter upon their return. From module 246, users may access module 206 in order to browse all matching parcels and from module 206 users may access module 205 in order to view the details regarding a particular parcel. From module 214, which can be accessed via any of the aforementioned modules, a hunter may rate a property which the hunter is shown to system 100 to have utilized historically and not previously rated, for example.

From login/welcome module 202, a new subscriber may access new subscriber module 224 which may, for example, permit the new subscriber (whether landowner or hunter or both) to enter identification information via module 226 and/or payment method via module 228. According to embodiments of the present invention, new subscriber module 224 permits system 100 to gather any necessary or desirable information about a new user of system 100, and to provide the new user with any information necessary to use system 100. From this point, or optionally from any module in FIG. 2 or other related module, the new subscriber may, for example, be returned to welcome screen 202 and/or modules 204, 230.

From login/welcome module 202, a landowner may use landowner module 230 to access functions associated with listing parcels for reservation. For example, a landowner may list available parcels via list parcels module 232, such as, for example, by entering an address or other geographic or spatial identification. Once a parcel has been listed, the landowner may use module 240 to list the availability, for example the spatial or temporal availability, of the parcel, or may enter restrictions or other rules regarding the parcel. From landowner module 230, the landowner may also rate hunters via module 234, such as, for example, hunters who have recently reserved and used a parcel made available for reservation by landowner via system 100. Landowner may also, via module 236, view past, current, or scheduled reservations or activity involving parcels owned or controlled by the landowner, by receiving a generated activity report; landowner may also run a query of the passcodes issued to current or scheduled hunters in order to confirm their identity and/or reservation authenticity. A landowner may edit listed parcels via module 238 such as, for example, changing their listed availability via module 242 or changing the description and/or rules and restrictions associated with the parcel via module 244.

Landowners who list land with reservation system 100 may be provided with signs (i.e. property postings) to be posted on the perimeter of their property and/or within their property indicating one or more of the following, for example: A) membership in the program, B) instructions for remotely reserving access to such land via RARS 100 via one or more SAPs 104, C) types of game present, D) rules of use, E) leasing rates, F) a unique property identifier code, and/or G) a unique code for each property tied to the specific property posting viewable by a participating hunter or prospective participating hunter at a particular property posting in which such unique code may correspond to the coordinates on a map (e.g. GPS location) including a map of such property with such unique codes within corresponding boundaries noted on such map. Such a unique code may be utilized to deliver property information for such unique property, to manage the number of participating hunter reservations accepted for a particular parcel/property during a particular day, week, month, season, and/or up to a specified quantity of game allowed to be harvested from such area.

Landowners may be provided a password or list of passwords each day, week, month or year (or other member-specified frequency) via one or more SAPs 104 in order to authenticate a hunter's right to access during a specified period. According to some embodiments of the present invention, a landowner my ask a hunter on the landowner's property to provide a password or other access code, and the landowner may then compare the provided access code with a predetermined access code provided by RARS 100, to authenticate the hunter as an authorized user of the property. According to such embodiments, participating landowners may access RARS 100 via SAPs 104 to verify the number of hunters and to authenticate the password(s) delivered to the landowner at any time as well as such the hunter's name(s), drivers license number(s), and/or hunting license number(s) in addition to any other relevant or desired information about such network member hunter.

According to embodiments of the present invention, participating landowners may manage via SAPs 104 the rates charged for land access utilizing either fixed rates for varying timeframes and/or numbers of hunters, auction such access via RARS 100, or use a combination of fixed rate and auction mechanisms including varying rights to access or rates based on the participating hunter's rating and review information, usage history, payment history, or other criteria. Participating landowners may also be able to rate and review hunters based on certain attributes, including but not limited to, cleanliness, following rules of use, courteousness, respect for other hunters and/or landowners, and accurate and timely recording of harvest counts. Landowners may also, through RARS 100 as well as provide text or audio reviews regarding such members and post such ratings and reviews to the system for broad access or keep such information only for such Member Landowners own private use.

Participating landowners may be able to review a hunter's ratings and reviews and use such information in determining which hunters receive access and/or the priority or rate charged. For example, hunters with higher ratings received from landowners for past land usage may receive preferential rates or priority land access. Participating landowners may also restrict access of their parcels to hunters with ratings of a certain minimum level. Participating hunters may subscribe to membership and by doing so access properties of participating landowners via RARS 100. According to some embodiments, member hunters (participating hunters) may reserve properties and/or parcels for a defined timeframe and/or for a defined number of hunters or rods via use of SAPs 104 utilizing unique property identification codes, passwords and/or unique access codes to identify and reserve such property for use.

Member hunters may access a searchable database via hunter module 246 of hunting properties by a variety of characteristics and attributes including but not limited to geographic location (county, state, distance from city, GPS coordinates), size, water, elevation, types of terrain, types of crops, types of wildlife, facilities, number of hunters and hunting dates desired, or unique property identification codes and be able to filter such results by a combination of characteristics and/or attributes, according to some embodiments of the present invention. Hunters, when reserving land for use, may be given a password serving as an authentication mechanism regarding the hunter's rights to access for a period of time and/or prescribed harvest count of permitted game. Member hunters may also access the system via the SAPs 104 following the hunters' use of a particular parcel and log the game harvested. Further, in some embodiments, participating hunters may rate and review their experiences with particular properties or parcels which they have reserved and used via the system. In some cases, such rating and review information may be posted via RARS 100 for public use by other participating hunters or landowners or held for the hunter's own private use via its access to system 100.

Embodiments of system 100 may enable hunters to view details of participating properties including satellite and topographical maps of property and game within, videos and pictures, descriptions of facilities, rules of use, hunting statistics on properties (such statistics indexed against other properties in the state, country or radius defined), and/or overall wildlife statistics for areas served by the system. Such embodiments of system 100 may also allow participating hunters to view game and accompanying game statistics via satellite imagery, and may also allow participating hunters to search satellite photography based on certain game statistics and/or desired game. Embodiments of system 100 may log participating hunters as well as information about non-members who “poach” (i.e. access participating landowner properties without a proper reservation) into the system by any or a combination of a driver's license number, hunting license number, social security number, name and date of birth, physical description, for example, and may have access denied based on certain guidelines for penalties (e.g. first offense leads to a one-year prohibition from participating in reservation system 100; second offense leads to a 5 years prohibition; and a third offense leads to a lifetime prohibition, for example).

According to some embodiments of the present invention, a reservation via system 100 may involve obtaining a passcode for an alpha-numeric gate or lock system, which would allow participating landowners to calibrate access to match unique passwords and/or access codes generated for the hunters by system 100, and may also permit participating landowners to program such gates or locks with updated behavior via a wireless chip which communicates to system 102. A reservation system 100 according to embodiments of the present invention may also provide hunter usage and reservation information to state or federal authorities for use in monitoring hunter activities and game harvesting.

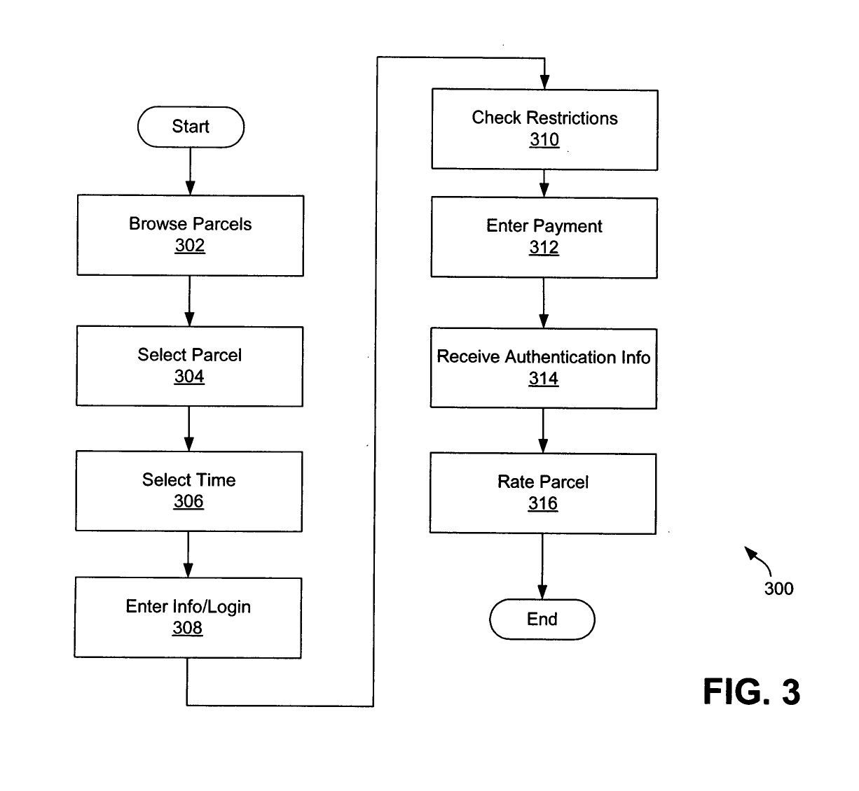

FIG. 3 illustrates an exemplary flow diagram 300 depicting methods for reserving access to parcels, according to various embodiments of the present invention. A user of the system 100, such as a hunter, may browse parcels (block 302). A parcel may be selected (block 304), such as, for example, by choosing a parcel from a browsed list, by entering a unique parcel code identifying the parcel, or by searching for a parcel based on supplied criteria. Such unique parcel codes may be posted, for example, via a sign on the particular parcel. The participating hunter next selects a time for usage of the parcel (block 306), and then enters the hunter's information; alternatively, the hunter's information may have already been provided during login to system 100 (block 308). Such entered information may include, but is not limited to, name, date of birth, driver's license number, hunter identification number, and/or social security number.

Next, restrictions may be checked to determine if the particular hunter is permitted to access the particular parcel (block 310). For example, the hunter's previous ratings by other hunters and/or landowners may be verified to ensure they fall above a certain minimum threshold, or the availability information about the parcel entered by the landowner may be referenced to determine compatibility with the requested time or number of hunters. Next, the participating hunter may enter payment (block 312), such as by entering credit card or debit account information. In return, the hunter may then receive authentication information (block 314). Such authentication information may include, for example, a password, access code, or numerical gate lock combination. Once the hunter has accessed and/or used the parcel, the hunter may rate the parcel (block 316) via system 100.

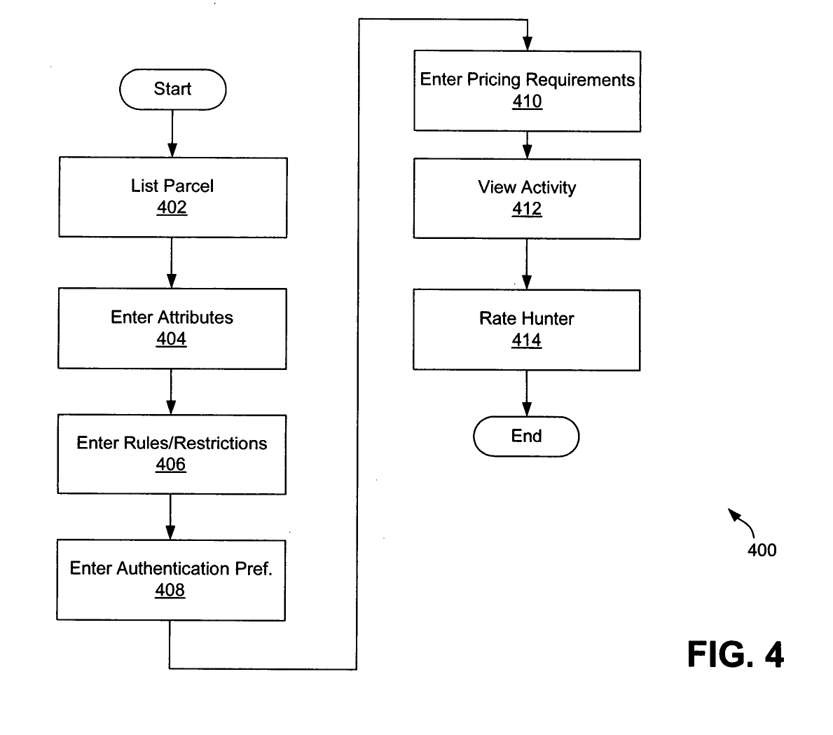

FIG. 4 illustrates an exemplary flow diagram 400 depicting methods for listing parcels, according to various embodiments of the present invention. A participating landowner may list a parcel by providing a name or other identification of the parcel (block 402). The landowner may also enter attributes about the parcel (block 404), such as, for example, geographic coordinates, boundaries, topography, water access, trail locations, topology, hazards, rights of way, easements, and/or game or fish populations. Next, the landowner may enter any rules or restrictions for the parcel (block 406). Such rules and restrictions may include, for example, times or days available for use, maximum number of simultaneous users, restrictions on the type of firearm, hunting weapon, fishing rod, or fishing bait permitted, or check-in/check-out requirements.

Next, the landowner may enter an authentication preference (block 408), such as, for example, authentication via face-to-face verification of generated access codes, sign-in at a gate, and/or numerical gate lock access code. The landowner may also enter pricing requirements for the parcel (block 410), such as, for example, a price per day per hunter, or a price per unit of game caught. Before, during, and after use of the parcel by one or more hunters, landowner may view activity related to the reservation and/or use of the parcel (block 412). For example, the landowner may query and/or view reservations made by hunters, or query a list of current users and their associated access codes and/or identification. Once a particular hunter has used the parcel, the landowner may rate the hunter (block 414) to provide information to other hunters or landowners, or for the landowner's future use.

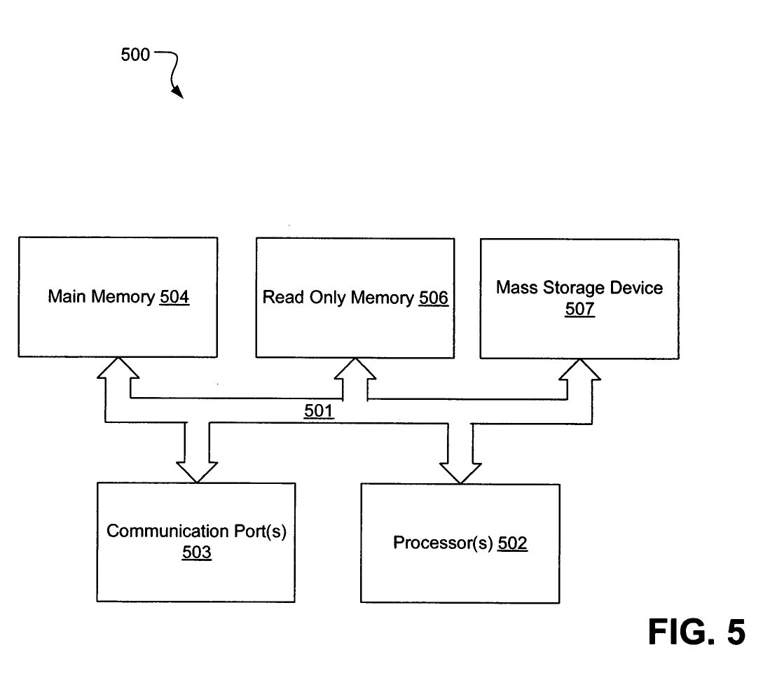

FIG. 5 is an example of a computer system 500 with which embodiments of the present invention may be utilized. Computer system 500 represents an exemplary system access point 104 and/or remote access reservation system 100 which may implement one or more of the methods discussed herein for facilitating reservation of access to hunting and/or fishing lands. In this simplified example, the computer system 500 comprises a bus 501 or other communication means for communicating data and control information, and one or more processing devices 502, such as a well known processor, Application Specific Integrated Circuit (ASIC), a field programmable gate array (FPGA), or the like, coupled with bus 501.

In this simplified embodiment, computer system 500 further comprises a random access memory (RAM) or other dynamic storage device (referred to as main memory 504), coupled to bus 501 for storing information and instructions to be executed by processing device 502. Main memory 504 also may be used for storing temporary variables or other intermediate information during execution of instructions by processor(s) 502.

Computer system 500 can also include a read only memory (ROM) 506 and/or other static storage device coupled to bus 501 for storing static information and instructions for processing device 502. A mass storage device 507, such as a magnetic disk or optical disc and its corresponding drive, may also be coupled to bus 501 for storing instructions and information, such as configuration files, a key store and registration database, etc. Such ROM 506 may comprise, for example, one or more databases in which information may be stored and/or retrieved, such as, for example, information received or sent via system 100, SAP 104, or the modules of FIG. 2.

One or more communication ports 503 may also be coupled to bus 501 for supporting network connections and communication of information to/from the computer system 500 by way of a communication network, such as a Local Area Network (LAN), Wide Area Network (WAN), or the Internet, for example. The communication ports 503 may include various combinations of well-known interfaces, such as one or more modems to provide network access, one or more 10/100 Ethernet ports, one or more Gigabit Ethernet ports (fiber and/or copper), or other well-known network interfaces commonly used in internetwork environments. In any event, in this manner, the computer system 500 may be coupled to a number of other network devices, communication devices, clients, NTMs, and/or servers via a conventional communication network infrastructure.

Optionally, operator and administrative interfaces (not shown), such as a display, keyboard, and a cursor control device, may also be coupled to bus 501 to support direct operator interaction with computer system 500. Other operator and administrative interfaces can be provided through network connections connected through communication ports 503.

Finally, removable storage media (not shown), such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 501 via corresponding drives, ports or slots.

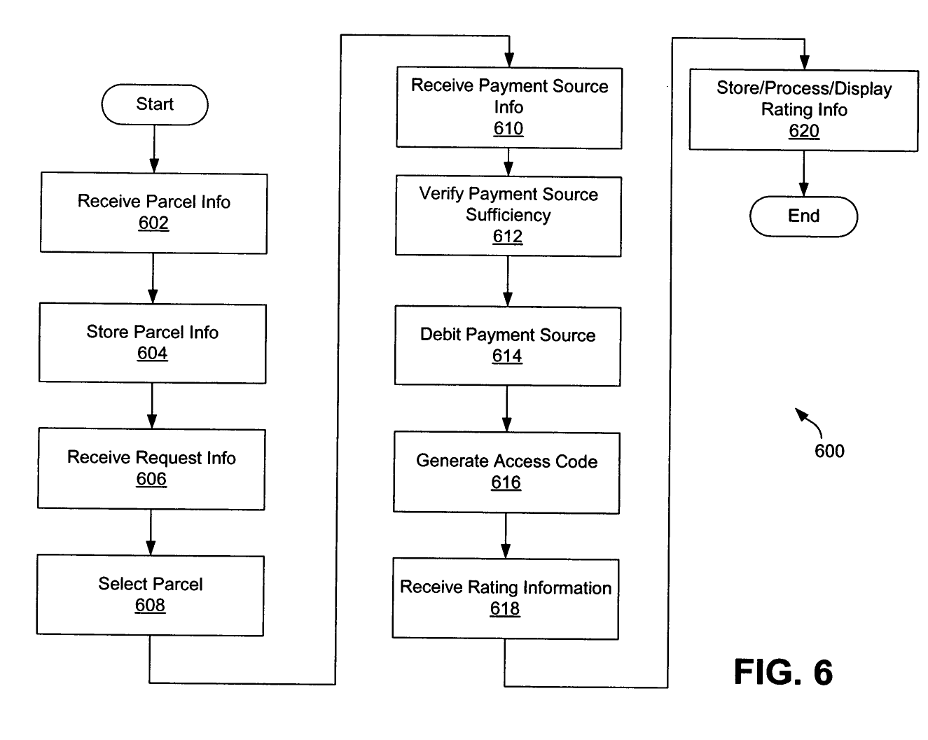

FIG. 6 illustrates a flow diagram 600 depicting methods for remote access reservation of parcels according to embodiments of the present invention. Parcel information may be received via a network for an available parcel associated with a particular landowner (block 602). Such parcel information may include, for example, a geographic identification of the available parcel, usage availability of the available parcel, usage pricing of the available parcel, game counts and historical harvesting statistics for such parcel and/or ratings for such parcel. The parcel information may be stored, for example, in a database containing information about several parcels (block 604). Such a database may be, for example, a collection of information stored in ROM 506 or mass storage device 507 and accessible by processor 502 of system 100, for example. Request information may be received via the network for a desired parcel (block 606). Such request information may include an identification of the desired parcel such as, for example, the parcel's geographic coordinates or a unique identification number associated with the parcel and/or posted on the property.

Parcels may be selected to be reserved (block 608). Provided such property has not already been screened for availability via entries into module 246, the user may screen such property for availability once selected. In the event such property meets the user's availability criteria, the user can optionally enter payment information into the system (block 610) provided such information is not on file with the user's membership profile. In the event such information is on file, the user may be prompted to confirm use of a particular payment method and such method(s), whether on file or entered ad hoc, may be verified for sufficiency of funds (block 612) and such funds may be debited (block 614). Once such reservation has been made and paid for the hunter may receive the unique passcode for such access (block 616). Following the use of such property, the user may enter ratings information into system 100 (block 618). Such ratings information may include a score system of many parameters and attributes including, but not limited to, overall quality of experience, abundance of game, courteousness of landowners, ease of access, quality of accommodations (to the extent applicable) and also allow for free form text to be entered in the form of a review. The ratings shall be posted and stored in system 100 (block 620). However, such ratings may optionally be kept private within system 100 and only be viewable by such member hunter via module 202 or be made available via system 100 to all member hunters (block 620), for example.

Embodiments of the invention have now been described in detail for purposes of clarity and understanding. However, it will be appreciated that certain changes and modifications may be practiced within the scope of the appended claims. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method for reserving access to hunting or fishing land, the method comprising:
listing a parcel of land as available for hunting or fishing via an access reservation system;
posting a unique identification code associated with the parcel of land on or adjacent to the parcel of land;
accessing the access reservation system to enter the unique identification code;
querying availability of the parcel of land based on the unique identification code; and
reserving the parcel of land based on the availability.

2. The method of claim 1, wherein reserving the parcel of land comprises generating a unique passcode for authenticating a user's right to use the parcel of land for a particular time period.

3. The method of claim 1, wherein accessing the access reservation system comprises communicating with the access reservation system via a communications system selected from the group consisting of: a telephone system, a network system, an internet system, and a wireless network system.

4. A method for reservation of land access activities, the method comprising:
receiving parcel information via a network for an available parcel associated with a particular landowner, the parcel information including a geographic identification of the available parcel, usage availability of the available parcel, and usage pricing of the available parcel;
storing the parcel information in a parcel database containing information about a plurality of parcels;
receiving request information via the network for a desired parcel, the request information including an identification of the desired parcel;
selecting a parcel from the plurality of parcels using criteria based on the request information; and
generating an access code granting physical access to the selected parcel for use in conformance with the parcel information.

5. The method of claim 4, wherein the access code is a combination for opening a security gate or other security device configured to prohibit public access.

6. The method of claim 4, wherein receiving request information via the network for the desired parcel comprises receiving information identifying the desired parcel selected from a list of parcels.

7. The method of claim 6, wherein the list of parcels is a list ordered by an order selected from the group consisting of: alphabetical order, geographic proximity order, and rating score order.

8. The method of claim 4, wherein the identification of the desired parcel is a unique identification number associated with the desired parcel, and wherein selecting the parcel from the plurality of parcels using criteria based on the request information comprises selecting the parcel associated with the unique identification number from the plurality of parcels.

9. The method of claim 4, further comprising:
receiving payment source information from a hunter interested in using the selected parcel;
verifying that the payment source is sufficient to satisfy the usage pricing for the selected parcel; and
debiting the payment source for an amount according to the usage pricing for the selected parcel.

10. The method of claim 4, further comprising:
generating an activity report for a landowner, the activity report listing the access codes and reservation times for use of the selected parcel.

11. The method of claim 4, further comprising:
receiving a rating score for the selected parcel from a user of the parcel;
storing the rating score in the database;
calculating an average rating score based on the rating score and other rating scores stored in the database and associated with the selected parcel; and
displaying the average rating score.

12. The method of claim 4, further comprising:
receiving from a landowner a rating score for a user of the landowner's parcel;
storing the rating score in the database;
calculating an average rating score based on the rating score and other rating scores stored in the database and associated with the user; and
displaying the average rating score.

13. A system for reservation of land access activities, the system comprising:
a computer, wherein the computer is communicably coupled to a computer readable medium and a network, and wherein the computer readable medium includes instructions executable by the computer to:
receive parcel information via the network for an available parcel associated with a particular landowner, the parcel information including a geographic identification of the available parcel, usage availability of the available parcel, and usage pricing of the available parcel;
store the parcel information in a parcel database containing information about a plurality of parcels;
receive request information via the network for a desired parcel, the request information including an identification of the desired parcel;
select a parcel from the plurality of parcels based on the request information; and
generate an access code granting physical access to the parcel for use in conformance with the parcel information.
